(19) United States
(12) Patent Application Publication
(10) Pub. No.: US 2026/0223266 A1
(43) Pub. Date: Jul. 30, 2026

(54) SENSOR DEVICE AND METHOD FOR ASSESSING AIR FLOW INFLUENCE

(71) Applicant: SIGNIFY HOLDING B.V., EINDHOVEN (NL)

(72) Inventors: JAN EKKEL, OSS (NL); HARRY BROERS, 's-Hertogenbosch (NL); ROGER PETER ANNA DELNOIJ, LOMMEL (BE); JOANNA GIBAS, EINDHOVEN (NL); JAMES MOAN, PEACHTREE CITY, GA (US); BRIAN SODERHOLM, PEACHTREE CITY, GA (US)

(21) Appl. No.: 19/147,005

(22) PCT Filed: Jan. 9, 2024
(86) PCT No.: PCT/EP2024/050322

§ 371 Date: Jul. 10, 2025

Related U.S. Application Data
(60) Provisional application No. 63/438,010, filed on Jan. 10, 2023.

(30) Foreign Application Priority Data
Feb. 13, 2023 (EP) 23156223.2

(51) Int. Cl. H05B 47/12; G01J 5/00; G01J 5/12; H04R 1/02

(52) U.S. Cl. CPC H05B 47/12; G01J 5/0025; G01J 5/12; H04R 1/028

(57) ABSTRACT

A sensor device (100) and a method (800) arranged to assess influence of air flow on sensor data are provided. The sensor device comprises a thermal sensor (130) arranged to register sensor data, S_{d}, a microphone (150) arranged to register audio data, A_{d}, generated from an air flow (170), and a processor (200) connected to the thermal sensor and the microphone. The processor is configured to obtain the registered sensor data and the registered audio data, based on the obtained audio data, estimate at least one property, Pᵢ, of an air flow, and based on at least one correlation criterion, C_{c}, between the sensor data and the audio data, estimate a level of influence, L_{f}, of the at least one property, Pᵢ, of the air flow on the sensor data.

### FIELD OF THE INVENTION

The present invention generally relates to a sensor device and a method for assessing air flow influence. More specifically, the present invention relates to a sensor device and a method which are able to detect “false” triggers due to air flow(s).

### BACKGROUND OF THE INVENTION

In the prior art, there are numerous devices and systems which comprise one or more sensors that can detect the presence and/or motions of persons. Devices of this kind are widely used in any kind of space such as offices, homes, etc., for switching on (off) the lights when one or more persons enter the space.

However, when not carefully placed, these (sensor) devices may react to “false” triggers, such as an on-switch of lights albeit no person enters and/or is present in the space. For example, if the device is arranged in the vicinity to a heating, ventilation and air conditioning (HVAC) outlet, false triggers by air flow may be likely to occur. It should be noted though, that especially within offices, this cannot always be prevented due to factors such as the existing HVAC infrastructure, desk position(s), luminaire grid, etc.

### SUMMARY OF THE INVENTION

Hence, it is desired to provide a device and a method which may be able to register sensor data (such as the presence and/or motion of one or more persons), and which may assess the influence from air flow(s) on the sensor data, e.g. in order to detect “false” triggers of the sensor data.

It is an object of the present invention to provide a device and a method which may register sensor data and assess the influence from any present air flow(s) on the sensor data.

This and other objects are achieved by providing a sensor device and a method having the features in the independent claims. Preferred embodiments are defined in the dependent claims.

Hence, according to a first aspect of the present invention, there is provided a sensor device arranged to assess influence of air flow on sensor data. The sensor device comprises a thermal sensor arranged to register sensor data, S_{d}, a microphone arranged to register audio data, A_{d}, generated from an air flow, and a processor connected to the thermal sensor and the microphone. The processor is configured to obtain the registered sensor data and the registered audio data, and based on the obtained audio data, estimate at least one property, Pᵢ, of an air flow. The processor is further configured to, based on at least one correlation criterion, C_{c}, between the sensor data and the audio data, estimate a level of influence, L_{f}, of the at least one property, Pᵢ, of the air flow on the sensor data.

According to a second aspect of the present invention, there is provided a method for assessing influence of air flow on sensor data. The method comprises the steps of registering sensor data, registering audio data generated from an air flow, obtaining the registered sensor data and the registered audio data, and based on the obtained audio data, estimating at least one property, Pᵢ, of an air flow. The method further comprises the step of based on at least one correlation criterion, C_{c}, between the sensor data and the audio data, estimating a level of influence, L_{f}, of the at least one property, Pᵢ, of the air flow on the sensor data.

Thus, the present invention is based on the idea of assessing air flow influence on sensor data, which in turn may reveal “false” triggers of sensor data (e.g. presence and/or motion sensor data) due to air flow. The sensor device estimates one or more properties, Pᵢ, of air flow from audio data (i.e. sound) and accordingly uses one or more correlations, C_{c}, between the sensor data and the audio data as registered to estimate the air flow's influence on the sensor data. Hence, the present invention efficiently uses both audio and sensor data, and the correlation(s), Cᵢ, thereof, in the evaluation of the air flow's impact on the sensor data.

The present invention is advantageous in that the sensor device is particularly effective in detecting air flow and estimating the influence thereof on sensor data. Consequently, the sensor device is efficient in detecting and/or recognizing false triggers of the sensor data, i.e. that an air flow may affect sensor data such that e.g. (false) presence/motion of person(s) could be triggered from an air flow albeit no person(s) is (are) present in a space. The sensor device is particularly advantageous in case a space or a room comprises a heating, ventilation and air conditioning (HVAC) outlet, as air flows from these arrangements may cause “false triggers” on the sensor data. By the assessment of the impact or influence of the air flow on the sensor data, the sensor device may conveniently and efficiently contribute to a management or processing of the sensor data, e.g. in order to compensate and/or ignore parts of the sensor data.

The present invention is further advantageous in that the ability of the sensor device to estimate air flow influence on sensor data, and, according to an example, the consequent ability to more accurately determine if there is person presence in a space or room or not, leads to an increased energy efficiency and/or an avoidance of non-intended lighting. For example, in case an air flow is generated and/or present in a space or room, although no person is present there, the assessment by the sensor device may be used by a lighting system or arrangement coupled to the sensor device to control the lighting accordingly (e.g. to keep the lighting off). In other words, air flow(s) triggering “false” motion events may erroneously lead to a lighting system or arrangement turning on light(s) although the space or room is non-occupied, a situation that the present invention counteracts.

The present invention is further advantageous in that the sensor device comprises relatively few components, which has several beneficial effects. For example, the present invention implies an easy installation, a non-obtrusiveness (due to its relatively small size), a construction which is not prone to malfunction, etc.

The sensor device arranged to assess influence of air flow on sensor data according to the first aspect of the present invention comprises a thermal sensor arranged to register sensor data, S_{d}. By “thermal sensor”, it is here meant substantially any thermal sensor such as e.g. a passive infrared (PIR) sensor, an infrared (IR) sensor, a thermopile sensor, etc. Consequently, by “sensor data”, it is here meant data registered by the thermal sensor, wherein the sensor data may emanate from e.g. a moving person, a moving fan, and/or a combination thereof. The sensor device further comprises a microphone arranged to register audio data generated from an air flow. Hence, the microphone of the sensor device registers audio data, e.g. in the form of noise, which is generated by the air flow. The sensor device further comprises a processor connected to the sensor and the microphone, wherein the processor is configured to obtain the registered sensor data and the registered audio data. Hence, the processor, which may be connected to the sensor and the microphone by a wireless or a wired connection, obtains or receives the sensor data and the audio data as registered. Based on the obtained audio data, the processor is configured to estimate at least one property, Pᵢ, of an air flow. Hence, the processor is configured to estimate one or more properties, Pᵢ, of an air flow being present. By the term “property”, it is here meant substantially any property or feature of the air flow such as magnitude (size, amplitude or strength) of the air flow. The processor is further configured to, based on at least one correlation criterion, C_{c}, between the sensor data and the audio data, estimate a level of influence, L_{f}, of the at least one property, Pᵢ, of the air flow on the sensor data. Thus, the processor is further configured to estimate a level of influence, L_{f}, of the air flow property(ies), Pᵢ, on the sensor data, i.e. to what degree or extent the air flow property(ies), Pᵢ, influence(s) the sensor data, based on one or more correlation criterions, C_{c}, between the sensor data and the audio data. By “correlation criterion”, it is here meant substantially any criterion with respect to a mutual relationship and/or connection between the sensor and audio data. The correlation criterion may be predefined. The correlation criterion may be stored in a memory, or the processor.

According to an embodiment of the present invention, the audio data, A_{d}, may comprise a spectrogram of amplitude as function of frequency. Hence, the audio data, A_{d}, as generated from the air flow, may comprise a (frequency) spectrogram, wherein the amplitude of the audio data, A_{d}, is a function of the frequency of the audio data, A_{d}. It should be noted that the audio data, A_{d}, spectrogram may indicate one or more properties, Pᵢ, of the air flow, and the present embodiment is advantageous in that the processor may be configured to deduce and/or estimate this (these) property(ies), Pᵢ, thereby improving the estimation of the level of influence, L_{f}, of the property(ies), Pᵢ, on the sensor data, S_{d}. For example, the spectrogram may indicate a magnitude of the air flow, and the processor may be configured to deduce and/or estimate the air flow magnitude based on the spectrogram. Hence, the present embodiment is advantageous in that the sensor device may efficiently evaluate the air flow's influence on the sensor data, S_{d}.

According to an embodiment of the present invention, the at least one property, Pᵢ, may comprise a magnitude of the air flow. By “magnitude”, it is here meant a size, extent, strength, speed, or the like, of the air flow. It should be noted that a relatively large air flow magnitude may significantly affect the sensor data, S_{d}, and the present embodiment is hereby advantageous in that the efficiency in detecting and/or recognizing false triggers of the sensor data is enhanced. For example, in case the processor estimates a relatively small magnitude of the air flow, the processor may estimate a relatively low or limited level of influence, L_{f}, of the air flow on the sensor data, S_{d}. In contrast, in case the processor estimates a relatively large magnitude of the air flow, the processor may estimate a relatively large or significant level of influence, L_{f}, of the air flow on the sensor data, S_{d}.

According to aspects, the thermal sensor may comprise a setting for detecting motion of at least one object in a space, wherein the processor may be configured to adapt said setting based on the estimated level of influence, L_{f}, of the at least one property, Pᵢ, of the air flow on the sensor data, S_{d}. Said setting may for example be a sensitivity of the thermal sensor. If said estimated level of influence exceeds a predefined threshold value, the processor may control the thermal sensor to decrease sensitivity.

For example, in an embodiment, the thermal sensor may comprise a sensitivity in sensing, wherein the processor may be configured to control the thermal sensor to decrease said sensitivity, if said estimated level of influence of the at least one property exceeds a predefined threshold value.

Said setting may for example be a detection mode of the thermal sensor.

For example, if said estimated level of influence exceeds a predefined threshold value, the processor may control the thermal sensor to turn off detection, i.e. operate at a non-detecting detection mode; and/or if said estimated level of influence is below a predefined threshold value, the processor may control the thermal sensor to remain detecting, i.e. operate at a detecting detection mode, i.e. detection turned on.

For example, in a different embodiment, the processor is configured to control the thermal sensor to stop registering sensor data, or: to temporarily stop registering sensor data, or: to stop sensing, when said estimated level of influence of the at least one property exceeds a predefined threshold value.

Such embodiments reduce false triggers, because the thermal sensor may not be falsely triggered by a detected air flow, for example caused by a HVAC, because either the thermal sensor is off, or the sensitivity is reduced.

According to an embodiment of the present invention, the sensor device may further comprise at least one element comprising at least one of an opening, a cavity and a recess, configured to generate an audible resonance for the air flow, wherein the obtained audio data comprises the audible resonance. Hence, the element(s) of the sensor device may generate an audible resonance for the air flow by standing waves in the opening, cavity and/or recess. The present embodiment is advantageous in that the sensor device may conveniently detect one or more properties, Pᵢ, of the air flow as a function of the characteristics of the audible resonance, such as air flow magnitude, for example. Consequently, this leads to an even more improved estimation of the level of influence, L_{f}, of the air flow on the sensor data, S_{d}, by the sensor device.

According to an embodiment of the present invention, the sensor device may further comprise a first accelerometer arranged to register first vibration data, V_{d1}, generated from the air flow, wherein the processor is connected to the first accelerometer and is configured to obtain the registered first vibration data, V_{d1}. The processor is further configured to, based on at least one correlation criterion, Ca, between the sensor data and the first vibration data, V_{d1}, estimate the level of influence, L_{f}, of the at least one property, Pᵢ, of the air flow on the sensor data, S_{d}. The present embodiment is advantageous in that the sensor device may conveniently detect one or more properties of the air flow based on the registered first vibration data, V_{d1}, generated from the air flow. Consequently, an even more improved estimation of the level of influence, L_{f}, of the air flow property(ies), Pᵢ, on the sensor data, S_{d}, may be achieved by the sensor device.

According to an embodiment of the present invention, the processor is further configured to, based on the obtained audio data, A_{d}, determine an operation of at least one fan. The processor is further configured to, based on at least one correlation criterion, C_{c2}, between the sensor data, S_{d}, and an operation of at least one fan, estimate the level of influence, L_{f}, of the air flow on the sensor data, S_{d}. Hence, the sensor device may determine and/or estimate that the air flow is generated by one or more fan(s) (instead of any air flow generated by other means, events, or the like, such as a moving person) and estimate the level of influence, L_{f}, of the air flow property(ies) on the sensor data accordingly. The present embodiment is advantageous in that an even more precise estimate of the air flow's influence on the sensor data, S_{d}, as a result of air fan operation, may be achieved.

According to an embodiment of the present invention, the sensor device may further comprise a magnetometer arranged to register magnetic data, Ma, generated from operation of at least one fan, wherein the processor is connected to the magnetometer and is configured to obtain the registered magnetic data. The processor is further configured to, based on at least one correlation criterion, Cₑ, between the sensor data and the magnetic data, estimate the level of influence, L_{f}, of the at least one property of the air flow on the sensor data, S_{d}. Hence, the processor may determine operation of one or more fans, and as the fan(s) during operation may generate a magnetic field, the sensor device may estimate the air flow influence on the sensor data based on the correlation between the sensor data and the magnetic data. By this, in addition to the correlation between the sensor data and the audio data, also the correlation between the sensor data and the magnetic data is taken into consideration by the sensor device upon estimation of the air flow's influence on the sensor data. The present embodiment is advantageous in that the sensor device may attain an even more precise estimate of the air flow's influence on the sensor data.

According to an embodiment of the present invention, the sensor device may further comprise a first temperature sensor arranged to register temperature data, wherein the first temperature sensor is arranged within a predetermined distance, d₁, of the thermal sensor and is connected to the processor. The processor is further configured to obtain the registered temperature data, and, based on the obtained temperature data, estimate the level of influence, L_{f}, of the at least one property, Pᵢ, of the air flow on the sensor data, S_{d}. By the wording “arranged within a predetermined distance, d₁”, it is here meant within a relatively small distance, d₁, or radius from the thermal sensor. Hence, the first temperature sensor may hereby register the temperature of the sensor device, or at least in the vicinity of the sensor device, which is correlated with ambient temperature. The present embodiment is advantageous in that an even more exact estimation of the level of influence, L_{f}, of the air flow property(ies), Pᵢ, of the air flow on the sensor data, S_{d}.

According to an embodiment of the present invention, the sensor device may further comprise a second temperature sensor arranged to register ambient temperature data, wherein the second temperature sensor is arranged beyond a predetermined distance, d₂, of the thermal sensor and is connected to the processor. The processor is further configured to obtain the registered ambient temperature data, and based on the obtained ambient temperature data, estimate the level of influence, L_{f}, of the at least one property, Pᵢ, of the air flow on the sensor data, S_{d}. By the wording “arranged beyond a predetermined distance, d₂”, it is here meant beyond a relatively large distance, d₂, or radius from the thermal sensor. Hence, in addition to the audio data and the sensor data, the processor of the sensor device may also take into account (ambient) temperature data for the estimate of air flow influence on the sensor data, S_{d}. For example, it may be assumed or expected that an air flow affects the temperature (e.g. by temperature increase, decrease, and/or fluctuation). The present embodiment is advantageous in that an even more exact determination of the property(ies), Pᵢ, of the air flow may be achieved, consequently leading to a more exact estimate of the influence of the air flow property(ies), Pᵢ, on the sensor data, S_{d}, by the sensor device of the present invention.

According to an embodiment of the present invention, there is provided a sensor arrangement arranged to detect motion of at least one object in a space, wherein the sensor arrangement comprises a sensor device according to any one of the preceding embodiments. The processor is further configured to detect motion of the at least one object in the space based on the estimated level of influence, L_{f}, of the at least one property, Pᵢ, of the air flow on the sensor data, S_{d}. By the term “object”, it is here commonly meant one or more persons. The present embodiment is particularly advantageous concerning the revelation of “false” triggers of sensor data (e.g. presence and/or motion sensor data of the object(s)) due to air flow. For example, in case of a relatively high estimated level of influence, L_{f}, of the air flow property(ies), Pᵢ, on the sensor data, S_{d}, by the sensor device, it may be estimated or determined that there is a relatively low possibility of object (person) presence or motion in a space. In contrast, in case of a relatively low estimated level of influence, L_{f}, of the air flow property(ies), Pᵢ, on the sensor data, S_{d}, by the sensor device, it may be estimated or determined that the likelihood of object(s) (person(s)) in the space is high.

According to an embodiment of the present invention, there is provided a sensor arrangement comprising at least one fan, wherein the audio data, A_{d}, is further generated from audible sound caused by operation of the at least one fan.

According to an embodiment of the present invention, the sensor arrangement may further comprise a second accelerometer arranged to register second vibration data, V_{d2}, generated from the at least one fan, wherein the processor is connected to the second accelerometer and is configured to obtain the registered second vibration data, V_{d2}, wherein, based on at least one correlation criterion, C_{g}, between the sensor data, S_{d}, and the second vibration data, V_{d2}, the processor is further configured to estimate the level of influence, L_{f}, of the at least one property, Pᵢ, of the air flow on the sensor data, S_{d}. Hence, the fan(s) may generate vibrations during operation, which may be registered by the second accelerometer, e.g. via the ceiling, and the processor may be configured to estimate the influence of the air flow on the sensor data, S_{d}, based on these vibrations. It should be noted that the first accelerometer arranged to register the first vibration data, V_{d1}, generated from the air flow, and the second accelerometer arranged to register second vibration data, V_{d2}, generated from the fan(s), may be different accelerometers, or alternatively, constitute one (single) accelerometer. In case the present embodiment of a (second) accelerometer is combined with the embodiment of a magnetometer of the sensor device, it should be noted that vibrations that result in vibration/movement of the fan(s) could also result in a varying magnetic field with respect to a static magnetic field.

According to an embodiment of the present invention, the sensor arrangement may further comprise a storage medium connected to the microphone and the processor, wherein the storage medium is configured to store the registered audio data. The processor is configured to determine a disrupted operation of the at least one fan based on the stored audio data. The present embodiment is advantageous in that the sensor arrangement may detect a malfunction and/or breakdown of the fan(s), and this information may be used by the sensor arrangement in the estimation of the influence of the one or more air flow properties, Pᵢ, on the sensor data.

According to an embodiment of the present invention, there is provided a lighting system, comprising at least one light source, and a sensor arrangement according to one or more of the previous embodiments. The sensor device is connected to the at least one light source and wherein the sensor device is configured to operate the at least one light source based on the detected motion of the at least one object in the space based on the estimated level of influence, L_{f}, of the at least one property, Pᵢ, of the air flow on the sensor data, S_{d}. It will be appreciated that the present embodiment is particularly advantageous concerning energy efficiency. For example, in case an air flow is generated and/or present in a space or room, although no person is present there, the assessment by the sensor device of a relatively high estimated level of influence, L_{f}, of the at least one property, Pᵢ, of the air flow on the sensor data, S_{d}, may be used by the lighting system to control the lighting accordingly (e.g. to keep the lighting off). In other words, air flow(s) triggering “false” motion events may erroneously lead to a lighting system or arrangement turning on light(s) although the space or room is non-occupied.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1a schematically shows a sensor device according to an exemplifying embodiment of the present invention,

FIG. 1b schematically shows an operation of the sensor device according to an exemplifying embodiment of the present invention,

FIG. 1c schematically shows a sensor device according to an exemplifying embodiment of the present invention,

FIGS. 2a-b schematically show the correlation between sensor data and audio data according to an exemplifying embodiment of the present invention,

FIGS. 3a-f schematically show correlations according to exemplifying embodiments of the present invention,

FIG. 4 schematically shows a lighting system according to an exemplifying embodiment of the present invention, and

FIG. 5 schematically shows a method according to an exemplifying embodiment of the present invention.

### DETAILED DESCRIPTION

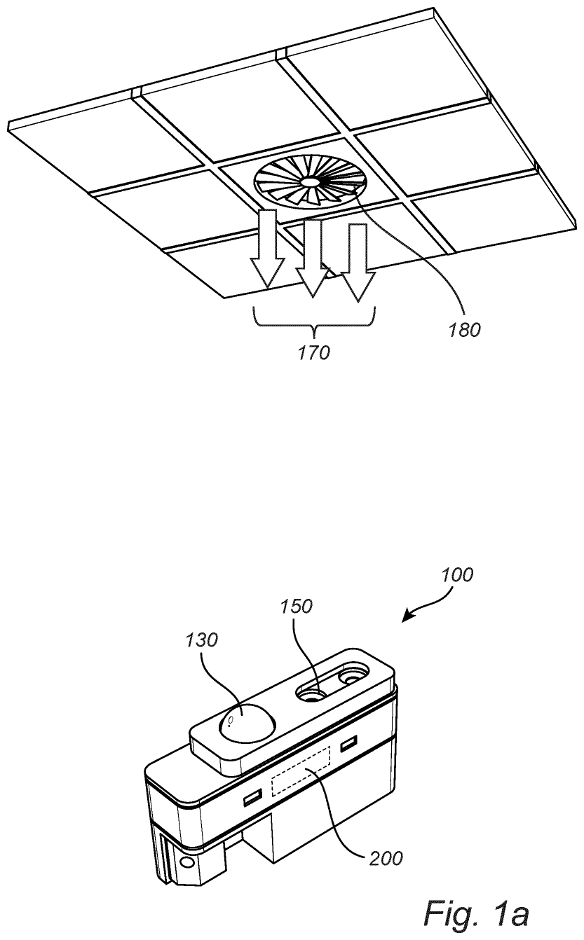

FIG. 1a schematically shows a sensor device 100 according to an exemplifying embodiment of the present invention. It will be appreciated that the properties of the sensor device 100 in FIG. 1a such as size, format apportionment, placement of its components, etc., are only provided as examples, and that the sensor device 100 as disclosed merely constitutes an example. The sensor device 100 comprises a thermal sensor 130 arranged to register sensor data, whereby the sensor data may emanate from e.g. a moving person, a moving fan, and/or a combination thereof. Albeit only a single thermal sensor 130 is shown, it will be appreciated that the sensor device 100 alternatively may comprise a plurality of thermal sensors 130. The thermal sensor 130 may, for example, be or comprise a passive infrared (PIR) sensor, an infrared (IR) sensor, a thermopile sensor, or the like. The thermopile sensor may be a single element thermopile sensor or a multi-element (array/matrix) thermopile sensor. The sensor device 100 is preferably arranged in a space or a room such that the thermal sensor 130 may conveniently register its sensor data in that space or room. The sensor device 100 further comprises a microphone 150 arranged to register audio data. Albeit only a single microphone 150 is shown, it will be appreciated that the sensor device 100 alternatively may comprise a plurality of microphones 150. The audio data may, for example, be in the form of noise generated by an air flow 170, wherein the air flow 170 in FIG. 1a is exemplified as an air flow 170 generated by a fan or a HVAC outlet 180 during operation. However, it will be appreciated that the air flow 170 may be generated from substantially any other element and/or situation, such as e.g. a window and/or a door ajar, and/or an opening of a window and/or a door, etc., whereby an air flow 170 is generated. The audio data may, for example, comprise a spectrogram of amplitude as function of frequency. Hence, the audio data as generated from the air flow 170, may comprise a (frequency) spectrogram, wherein the amplitude of the audio data is a function of the frequency of the audio data.

The sensor device 100 further comprises a processor 200 connected to the thermal sensor 130 and the microphone 150. The processor 200 is merely schematically indicated in FIG. 1a by dashed lines, as it should be noted that the processor 200 may be integrated in the sensor device 100, or alternatively, be remotely arranged from the housing of the sensor device 100. Hence, the processor 200 may be connected to the sensor 130 and the microphone 150 by a wireless or a wired connection.

FIG. 1b schematically shows an operation of the sensor device 100 as exemplified in FIG. 1a according to an exemplifying embodiment of the present invention. In the leftmost part of FIG. 1b, the sensor data, S_{d}, as registered by the thermal sensor 130, and the audio data, A_{d}, as registered by the microphone 150, are obtained or received by the processor 200. Based on the obtained audio data, A_{d}, the processor 200 is configured to estimate at least one property, Pᵢ, of an air flow. For example, the processor 200 may be configured to estimate a magnitude (size, strength) of an air flow. The processor 200 is further configured to, based on at least one correlation criterion, C_{c}, between the sensor data, Sa, and the audio data, A_{d}, estimate a level of influence, L_{f}, of the at least one property, Pᵢ, of the air flow on the sensor data, S_{d}. Thus, the processor 200 estimates one or more air flow properties, Pᵢ, and estimates a level of influence, L_{f}, of the air flow property(ies), Pᵢ, on the sensor data, S_{d}, i.e. to what degree or extent the air flow property(ies), Pᵢ, influence(s) the sensor data, S_{d}, based on one or more correlation criterions, C_{c}, between the sensor data, S_{d}, and the audio data, A_{d}. In case the audio data, A_{d}, comprises a spectrogram of amplitude as function of frequency, the spectrogram may indicate one or more properties, Pᵢ, of the air flow 170, and the processor 200 may hereby be configured to deduce and/or estimate this (these) property(ies), Pᵢ, for the estimation of the level of influence, L_{f}, of the property(ies), Pᵢ, on the sensor data, S_{d}. For example, the spectrogram may indicate a magnitude of the air flow 170, and the processor 200 may be configured to deduce and/or estimate the air flow 170 magnitude based on the spectrogram.

FIG. 1c schematically shows a sensor device 100 according to an exemplifying embodiment of the present invention. It will be appreciated that the sensor device 100 in FIG. 1c has many features in common with the sensor device 100 as exemplified in FIG. 1a and the associated text, and the operation thereof, as exemplified in FIG. 1b and the associated text, and it is referred to this (these) text(s) and/or figure(s) for an increased understanding. The sensor device 100 in FIG. 1c further comprises a first temperature sensor 300 arranged to register temperature data. The first temperature sensor 300 is exemplified as being arranged on the housing of the sensor device 100. Alternatively, the first temperature sensor 300 may be arranged within a (first) predetermined distance, d₁, of the thermal sensor 130. The processor 200 may hereby be configured to obtain the registered temperature data by the first temperature sensor 300, and based thereon, estimate the level of influence, L_{f}, of the at least one property, Pᵢ, of the air flow on the sensor data, S_{d}. The sensor device 100 may further comprise a second temperature sensor 310 arranged to register ambient temperature data, wherein the second temperature sensor 310 is arranged beyond a (second) predetermined distance, d₂, of the thermal sensor 130. The processor 200 may hereby be configured to obtain the registered ambient temperature data, and based thereon, estimate the level of influence, L_{f}, of the at least one property, Pᵢ, of the air flow on the sensor data, S_{d}. In case of the sensor device 100 having a first and second temperature sensors 300, 310, the first temperature sensor 300 may be arranged in a vicinity of the thermal sensor 310 and the second temperature sensor 310 may be arranged remotely from the thermal sensor 310, such that d₂>>d₁.

The sensor device 100 in FIG. 1c further comprises a storage medium 620 connected to the microphone 150 and the processor 200. The storage medium 620 is configured to store the registered audio data, and wherein the processor 200 is configured to determine a disrupted operation of fan(s) based on the stored audio data.

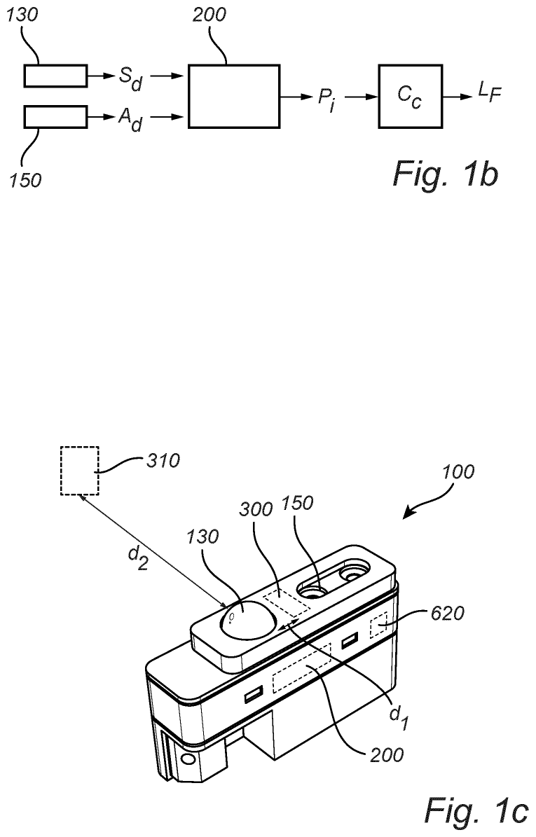

FIG. 2a schematically shows the correlation between sensor data, S_{d}, and audio data, A_{d}, according to an exemplifying embodiment of the present invention. In this exemplifying setup, a ceiling fan was used and operated. The ceiling fan was switched “on” and “off” six times consecutively, for each of a low setting, S1, a medium setting, S2, and a high setting, S3, of the ceiling fan speed, wherein the “on” and “off” periods were 10 seconds and 5 seconds, respectively. The noise from the air flow generated by the ceiling fan, i.e. the audio data, A_{d}, shown in the upper part of FIG. 2a, was recorded (registered) by the microphone of the sensor device. Furthermore, the thermal sensor of the sensor device registered sensor data, S_{d}, emanating from the ceiling fan operation, shown in the lower part of FIG. 2a as raw dual channel sensor data, S_{d}. FIG. 2a shows a correlation between the sensor data, S_{d}, and the audio data, A_{d} (which is even more clearly shown by the zoomed-in view of FIG. 2b). Based on one or more correlation criterion(s), C_{c}, between the sensor data, S_{d}, and the audio data, A_{d}, the sensor device is configured or arranged to estimate a level of influence, L_{f}, of the air flow property(ies) on the sensor data, S_{d}.

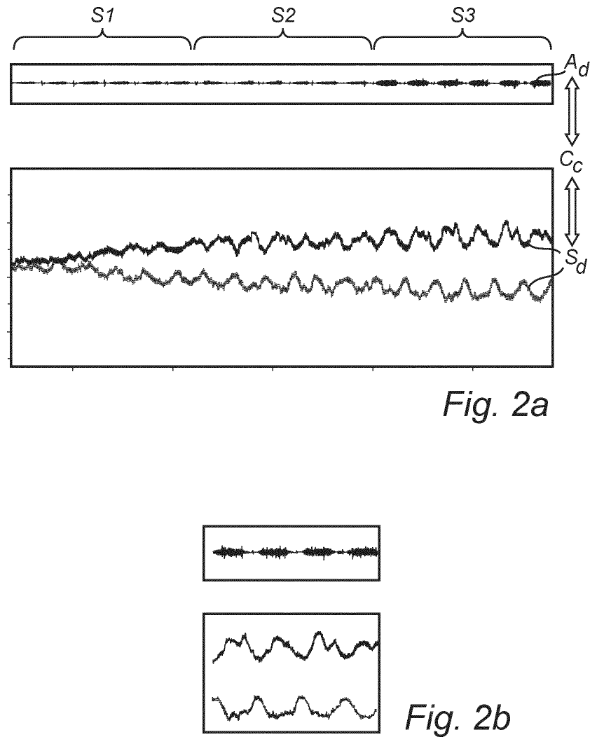

FIGS. 3a-f schematically show correlations for estimating the level of influence of the at least one property of the air flow on the sensor data according to exemplifying embodiments of the present invention.

FIG. 3a shows an example of the processor of the sensor device of the present invention being configured to estimate a level of influence, L_{f}, of the at least one property of the air flow on the sensor data, S_{d}, based on at least one correlation criterion, C_{c}, between the sensor data, S_{d}, and the audio data, A_{d}.

In FIG. 3b, the processor is further configured to estimate the level of influence, L_{f}, of the at least one property of the air flow on the sensor data, S_{d}, based on a first correlation criterion, C_{c1}, of the correlation criterion(s), C_{c}, between the sensor data, S_{d}, and the estimated magnitude (size, strength), As, of the air flow based on the audio data, A_{d}.

In FIG. 3c, the processor is configured to estimate the level of influence, L_{f}, of the at least one property of the air flow on the sensor data, S_{d}, both via the correlation criterion, C_{c}, between the sensor data, S_{d}, and the audio data, A_{d}, according to FIG. 3a, as well as via a correlation criterion, Ca, between the sensor data, S_{d}, and first vibration data, V_{d1}, generated from the air flow.

In FIG. 3d, the processor is configured to, based on the obtained audio data, A_{d}, determine, Lₗ, an operation of at least one fan. The processor is further configured to estimate the level of influence, L_{f}, of the at least one property of the air flow on the sensor data, S_{d}, based on at least one correlation criterion, Cₑ, between the sensor data, S_{d}, and the determined operation, Lₗ, of at least one fan.

In FIG. 3e, the processor is configured to obtain registered magnetic data, Ma, generated from operation of the fan(s). The processor is configured to estimate the level of influence, L_{f}, of the at least one property of the air flow on the sensor data, S_{d}, both via the correlation criterion, C_{c}, between the sensor data, S_{d}, and the audio data, A_{d}, according to FIG. 3a, as well as via a correlation criterion, Cf, between the sensor data, S_{d}, and the magnetic data, Ma.

In FIG. 3f, the processor is configured to estimate the level of influence, L_{f}, of the at least one property of the air flow on the sensor data, S_{d}, both via the correlation criterion, C_{c}, between the sensor data, S_{d}, and the audio data, A_{d}, according to FIG. 3a, as well as via a correlation criterion, C_{g}, between the sensor data, S_{d}, and second vibration data, V_{d2}, generated from the at least one fan.

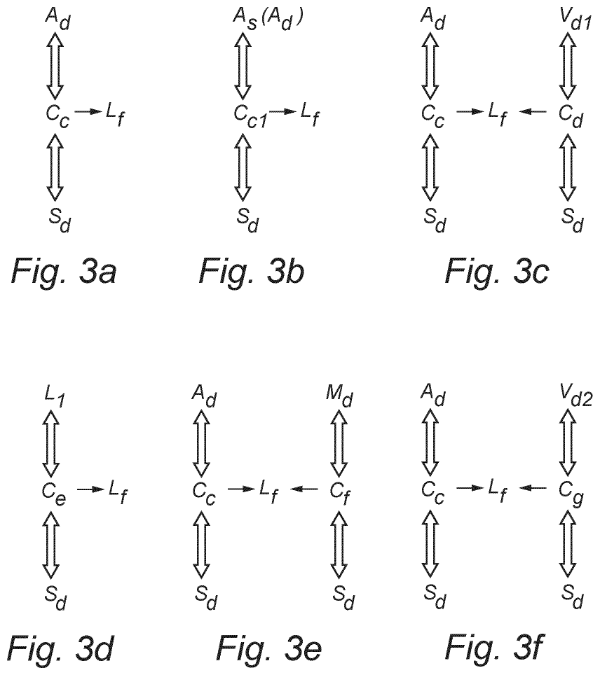

FIG. 4 schematically shows a lighting system 700 according to an exemplifying embodiment of the present invention. The lighting system 700 comprises at least one light source 710, which is exemplified as a luminaire arranged in the ceiling of a space or room 120. The lighting system 700 further comprises a sensor arrangement which in turn comprises a sensor device 100, according to any one of the preceding embodiments of the invention, which is connected to the light source(s) 710. It will be appreciated that the arrangement of the sensor device 100 on/at the light source(s) 710 is only shown as an example of the lighting system 700, and that the sensor device 100 alternatively may be arranged separately from the light source(s) 710. In accordance with one or more previously described embodiments of the present invention, the processor (not shown) of the sensor device 100 of the sensor arrangement is configured to detect motion 185 of at least one object (person) 110 in the space 120 based on the estimated level of influence of the at least one property of an air flow on the sensor data. According to the example of FIG. 4, the sensor arrangement may, for example, comprise a HVAC outlet 180 arranged in the ceiling of the space or room 120, wherein the HVAC outlet 180 during operation generates an air flow 170. However, it will be appreciated that the air flow 170 may be generated from substantially any other element and/or situation, such as e.g. an open(ing) window and/or an open(ing) door of the space or room 120, whereby an air flow 170 is generated. This operation of the sensor device 100 for assessing influence of the air flow 170 on the sensor data may be explained and exemplified according to the following. The thermal sensor (not shown) of the sensor device 100 is arranged to register sensor data, S_{d}, in the form of presence and/or motion data 185 of the person 110, motion of the ceiling fan 180, etc. The microphone (not shown) of the sensor device 100 is arranged to register audio data, A_{d}, generated from the air flow 170. The sensor device 100 is configured to estimate a level of influence of the air flow 170 property(ies) on the sensor data based on correlation criterion(s) between the sensor data, S_{d}, and the audio data, A_{d}, and the sensor device 100 is further configured to operate the light source(s) 710 based on the estimated level of influence of the at least one property of the air flow 170 on the sensor data, S_{d}. Hence, the sensor device 100 is arranged or configured to detect “false” triggers of the sensor data due to the air flow 170, and compensate for this when detecting motion 185 of the object(s) (person(s)) 110 in the space 120.

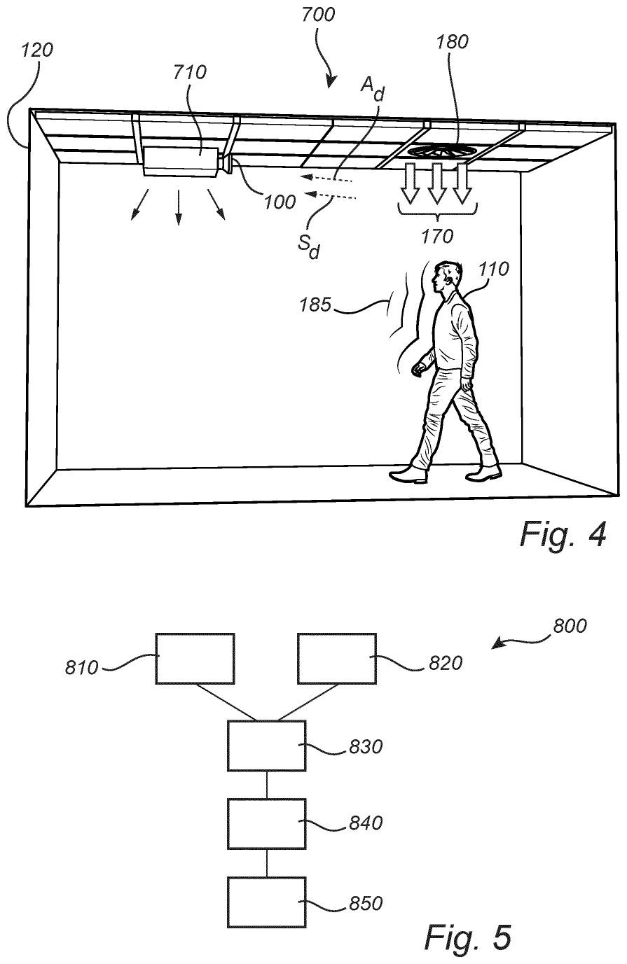

FIG. 5 schematically indicates a method 800 for assessing influence of air flow on sensor data. The method 800 comprises the steps of registering 810 sensor data and registering 820 audio data generated from an air flow. The method 800 further comprises the steps of obtaining 830 the registered sensor data and the registered audio data, and based on the obtained audio data, estimating 840 at least one property of an air flow. The method 800 further comprises the step of, based on at least one correlation criterion, C_{c}, between the sensor data and the audio data, estimating 850 a level of influence, L_{f}, of the at least one property of the air flow on the sensor data.

The person skilled in the art realizes that the present invention by no means is limited to the preferred embodiments described above. On the contrary, many modifications and variations are possible within the scope of the appended claims. For example, the size, number, positioning, etc., of one or more elements of the sensor device 100 may be different than that/those shown.

1. A sensor device arranged to assess influence of air flow on sensor data, wherein the sensor device comprises
a thermal sensor arranged to register sensor data, S_{d},
a microphone arranged to register audio data, A_{d}, generated from an air flow,
a processor connected to the thermal sensor and the microphone, wherein the processor is configured to obtain the registered sensor data, S_{d}, and the registered audio data, A_{d},
based on the obtained audio data, A_{d}, estimate at least one property, Pᵢ, of an air flow, and
based on at least one correlation criterion, C_{c}, between the sensor data, S_{d}, and the audio data, A_{d}, estimate a level of influence, L_{f}, of the at least one property, Pᵢ, of the air flow on the sensor data, S_{d}.

2. The sensor device according to claim 1, wherein the audio data, A_{d}, comprises an audio spectrogram of amplitude as a function of frequency.

3. The sensor device according to claim 1, wherein the at least one property, Pᵢ, comprises a magnitude of the air flow.

4. The sensor device according to claim 1, wherein the thermal sensor comprises a sensitivity in sensing, wherein the processor is configured to control the thermal sensor to decrease said sensitivity, if said estimated level of influence of the at least one property exceeds a predefined threshold value.

5. The sensor device according to claim 1, wherein the processor is configured to control the thermal sensor to stop registering sensor data, when said estimated level of influence of the at least one property exceeds a predefined threshold value.

6. The sensor device according to claim 1, further comprising at least one element comprising at least one of an opening, a cavity and a recess, configured to generate an audible resonance for the air flow, wherein the obtained audio data, A_{d}, comprises the audible resonance.

7. The sensor device according to claim 1, further comprising
a first accelerometer arranged to register first vibration data, V_{d1}, generated from the air flow,
wherein the processor is connected to the first accelerometer and is configured to obtain the registered first vibration data, Va, wherein the processor is further configured to
based on at least one correlation criterion, Ca, between the sensor data, S_{d}, and the first vibration data, V_{d1}, estimate the level of influence, L_{f}, of the at least one property, Pᵢ, of the air flow on the sensor data, S_{d}.

8. The sensor device according to any one of the preceding claim 1,
wherein the processor is further configured to based on the obtained audio data, A_{d}, determine an operation, L₁, of at least one fan, wherein the processor is further configured to
based on at least one correlation criterion, Cₑ, between the sensor data, S_{d}, and an operation of at least one fan, estimate the level of influence, L_{f}, of the at least one property, Pᵢ, of the air flow on the sensor data, S_{d}.

9. The sensor device according to claim 1, further comprising a first temperature sensor arranged to register temperature data, wherein the first temperature sensor is arranged within a predetermined distance, d₁, of the thermal sensor and is connected to the processor, wherein the processor is further configured to
obtain the registered temperature data,
based on the obtained temperature data, estimate the level of influence, L_{f}, of the at least one property, Pᵢ, of the air flow on the sensor data, S_{d}.

10. A sensor arrangement arranged to detect motion of at least one object in a space, wherein the sensor arrangement comprises
a sensor device according to claim 1,
wherein the processor is further configured to
detect motion of the at least one object in the space based on the estimated level of influence, L_{f}, of the at least one property, Pᵢ, of the air flow on the sensor data, S_{d}.

11. The sensor arrangement according to claim 10, further comprising
at least one fan,
wherein the audio data, A_{d}, is further generated from audible sound caused by operation of the at least one fan.

12. The sensor arrangement according to claim 11, further comprising
a second accelerometer arranged to register second vibration data, V_{d2}, generated from the at least one fan,
wherein the processor is connected to the second accelerometer and is configured to obtain the registered second vibration data, V_{d2}, wherein the processor is further configured to
based on at least one correlation criterion, C_{g}, between the sensor data, S_{d}, and the second vibration data, V_{d2}, estimate the level of influence, L_{f}, of the at least one property, Pᵢ, of the air flow on the sensor data, S_{d}.

13. The sensor arrangement according to claim 10, further comprising
a storage medium connected to the microphone and the processor, wherein the storage medium is configured to store the registered audio data, A_{d}, and wherein the processor is configured to determine a disrupted operation of the at least one fan based on the stored audio data, A_{d}.

14. A lighting system, comprising
at least one light source,
a sensor arrangement according to claim 10, wherein the sensor device is connected to the at least one light source and wherein the sensor device is configured to operate the at least one light source based on the detected motion of the at least one object in the space based on the estimated level of influence, L_{f}, of the at least one property, Pᵢ, of the air flow on the sensor data, S_{d}.

15. A method for assessing influence of air flow on sensor data, comprising the steps of
registering sensor data, S_{d},
registering audio data, A_{d}, generated from an air flow,
obtaining the registered sensor data, S_{d}, and the registered audio data, A_{d},
based on the obtained audio data, A_{d}, estimating at least one property, Pᵢ, of an air flow,
based on at least one correlation criterion, C_{c}, between the sensor data, S_{d}, and the audio data, A_{d}, estimating a level of influence, L_{f}, of the at least one property, Pᵢ, of the air flow on the sensor data, S_{d}.
